(19) United States
(12) Patent Application Publication
(10) Pub. No.: US 2002/0087223 A1
(43) Pub. Date: Jul. 4, 2002

(54) Computerized golf scoring and communication system

(76) Inventors: Devin Lawrence Moffatt, Fergus (CA); James Gavin Cole Palmer, Rockwood (CA)

Correspondence Address: Elias C. Borges, 10 Kingsbridge Garden Circle, Suite 704, Mississauga, ON, L5R 3K6, CA

(21) Appl. No.: 10/021,786

(22) Filed: Dec. 17, 2001

(30) Foreign Application Priority Data
Jan. 3, 2001 (CA) 2,330,060

(51) Int. Cl. G06F 155/00

(52) U.S. Cl. 700/92; 700/91; 700/93

(57) ABSTRACT

A computer scoring and communication system for use by golfers on a golf course is disclosed. The scoring and communication system includes a computer server having a communications interface and a computer memory, a plurality of remote computer consoles, each console mounted adjacent a tee box, each said console having a computer display screen and a data inputting device whereby the golfers can enter information into the console, each remote computer console operatively coupled to the communications interface of the server via a communications network. The computer server is adapted and configured to retrieve the information from each remote computer console and store said information in the memory. The computer server is further adapted and configured to send messages to the remote computer consoles, said remote computer consoles adapted to display the messages on their computer display screens.

### FIELD OF THE INVENTION

The invention relates generally to computerized golf scoring systems.

### BACKGROUND OF THE INVENTION

Computerized golf scoring systems have been attempted in the past. Generally, these systems consisted of hand held calculator type devices which assisted the golfer in keeping score. These devices often had a liquid crystal display for displaying the score, hole and player information, a keypad for entering scoring data and a computer memory for displaying current and historical scoring data. These devices have been quite popular with golfers, since it permits them to track their game over a period of time, are portable and are relatively inexpensive.

Where several golfers are playing in an informal competition, hand held computer devices are not very useful, since they are generally operated by only one person. Computerized golf scoring systems have been developed to simultaneously record the scores of several different players playing different holes. U.S. Pat. No. 5,949,679 to Born et al. discloses one such computer system. The Born computer scoring system consists of a series of remote computer consoles operatively coupled to a main computer via a communications network. Each hole in the golf course is provided with a remote computer console. As players play a round of golf, scoring information is entered into the consoles and communicated back to the main computer which calculates and records the score from each player. The main computer may also be connected to the Internet to exchange golf score information with other computers.

While existing computer scoring devices are adequate for the job they perform, they do not meet the increased requirements of golfers. Generally, these computer network scoring systems are not very appealing to golfers since they are complicated to use and only provide the golfer with scoring information. Since golfers can choose from a plurality of inexpensive, portable golf score devices currently available on the market, it is difficult to justify the costs of installing a golf course computer network. Accordingly, there is a need for computerized golf scoring system which is easy to use and sufficiently appealing to golfers to be profitable.

### SUMMARY OF THE INVENTION

The present invention is a computer scoring and communication system for use by golfers on a golf course having holes and tee boxes. The scoring and communication system includes a computer server having a communications interface and a computer memory, a plurality of remote computer consoles, each console mounted adjacent a tee box, each said console having a computer display screen and a data inputting device whereby the golfers can enter information into the console, each remote computer console operatively coupled to the communications interface of the server via a communications network. The computer server is adapted and configured to retrieve the information from each remote computer console and store said information in the memory. The computer server is further adapted and configured to send messages to the remote computer consoles, said remote computer consoles adapted to display the messages on their computer display screens.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention, in which:

### DESCRIPTION OF THE DRAWINGS

FIG. 1 is a schematic view of the computerized golf scoring system of the present invention showing a single remote computer console.

FIG. 2 is a schematic view of the computerized golf scoring system of the present invention showing a plurality of remote computer consoles.

In the drawings like characters of reference indicate corresponding parts in the different figures.

### DETAILED DESCRIPTION OF THE PREFERRED EMBODIMENT

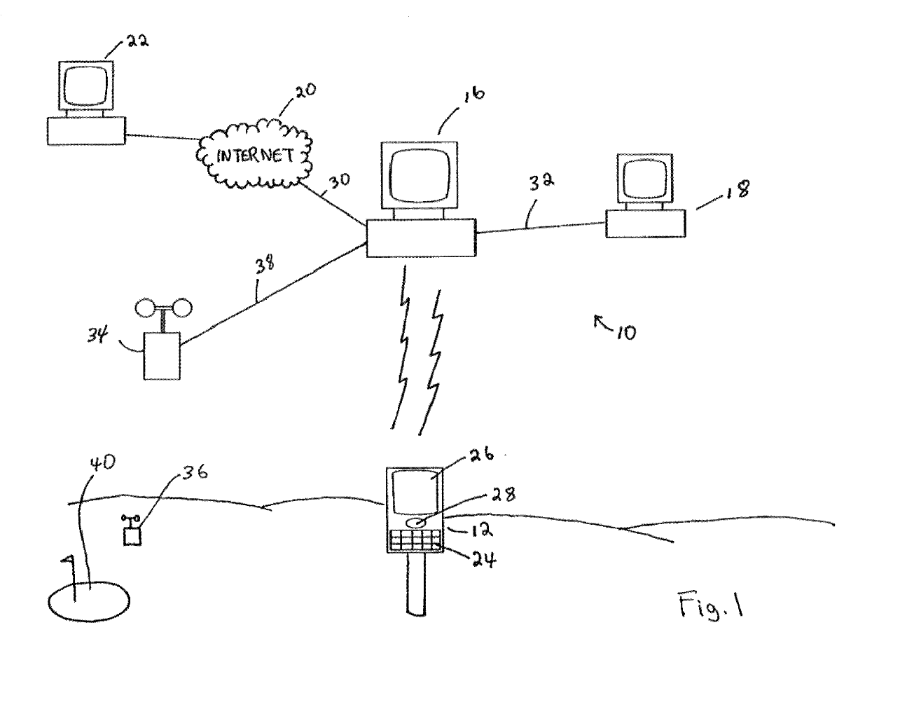

Referring firstly to FIG. 1, a computerized golf scoring and communication system made in accordance with the present invention is shown generally as item 10 and consists of a plurality of remote computer consoles positioned along golf course 14, computer server 16 operatively coupled to computer consoles 12, work station 18 operatively coupled to computer server 16. Computer server 16 is operatively coupled to the world wide web, 20, which is in turn accessible by remote computers 22. Computer console 12 consists of an inter-active computer console having a display screen 26, a computer inputting device 24, and an audio interface 28. Inputting device 24 can consist of a computer keyboard, a joy-stick, a roller ball, a touch-pad or some other interface which permits a user to input information into computer console 12. Computer console 12 is positioned on golf course 14 adjacent a golf-teeing area. At least one computer console 12 would be positioned on the teeing area of each hole of golf course 14. Computer consoles 12 are operatively coupled to computer server 16 via a cable or via a wireless communication network. The wireless communication network can consist of a radio modem, or may even consist of a cellular telephone connection. Suitable wireless communication networks are readily available in the marketplace. Computer console 12 is provided with a computer interface (not shown) which permits computer console 12 to communicate with the corresponding communications interface and computer server 16. Audio interface 28 of computer console 12 preferably consists of a speaker/microphone combination which permits audible signals, such as public announcements and the like to be broadcast from the audio interface. Audio interface 28 is also adapted to permit a user positioned adjacent computer console 12 to give a verbal signal to computer console 12 via the audio interface. Audio interface 28 is adapted to convert the verbal signal from the user into digital information which can be stored within computer console 12 and then re-transmitted to computer server 16. Likewise, computer server 16 may send an electronic signal to computer console 12 which can be transformed by audio interface 28 into a sound signal which can be heard by a user standing adjacent the computer console. Various computer sound cards are presently available on the market which have the capacity to convert audio signals into digital signals and digital signals back into audio signals.

Preferably computer console 12 would also be sufficiently robust that it could withstand a limited amount of exposure to the weather. Suitable computer consoles having adequate display screens, audio interfaces, inputting devices and communications interfaces are presently available in the marketplace. Many of these commercially available computer consoles are also sufficiently weather resistant that they can be mounted outside in a golf course with a minimum amount of sheltering. Computer console 12 can be powered by any suitable power source (not shown) such as solar panels, rechargeable batteries or a direct power line.

Server 16 is located in a portion of the golf course which generally houses the pro-shop or the administrative offices for the course and is operatively coupled to the plurality of remote computer consoles 12 via the communications network. Preferably server 16 consists of a commercially available computer server which is pre-loaded with networking software which enables server 16 to communicate directly with each computer console 12. Computer server 16 is also operatively coupled to the world-wide web via communications line 30. Communications line 30 can consist of a regular telephone line or a high speed Internet connection. Computer servers 16 is pre-loaded with software which is capable of exchanging information with computer consoles 12. In particular, computer server 16 has a database program which is adapted and configured to store information from each computer console 12. This computer database is further configured such that the information contained in the database can be accessed by remote computer 22 via the worldwide web 20.

Work station 18 is operatively coupled to server 16 via communications line 32. Work station 18 may be located in the same facility as computer server 16; however, in most practical applications the work station will be located in a club house or other portion of the golf course where golfers tend to congregate for refreshments, either before or after a golf game. Work station 18 is pre-loaded with computer software which is adapted to communicate with server 16 such that information stored in server 16 can be displayed on work station 18.

Server 16 is operatively coupled to weather station 34 via communication line 38. Weather station 34 is adapted to measure the speed and direction of the wind and convert that information into a first and second digital signal. Weather station 34 is further adapted to transmit the first and second signal to server 16 via communications line 38. Server 16 is preloaded with software which translates the first and second signals into wind speed and direction information which is stored in the database. Computer console 12 may also be operatively coupled to a weather station 36 positioned on the golf-course somewhere between the computer console and green 40. Weather station 36 is adapted and configured to measure the speed and direction of the wind, the temperature, the amount of rainfall and other pertinent weather information which may be required by golfers. This weather information is converted by weather station 36 into digital signals which can be read by computer console 12 and displayed on computer screen 26. Digital signals from weather station 36 may also be transmitted to a computer server 16 via computer console 12 such that computer server 16 may gather information about weather stations 36 throughout golf course 14. Information concerning the weather conditions at each hole in the course is stored in server 16 and can be made available to computer consoles 12, computer work station 18 and remote computer 22. In this way, a golfer can determine the weather conditions at any part in the course simply by consulting computer consoles 12, or computers 18 or 22.

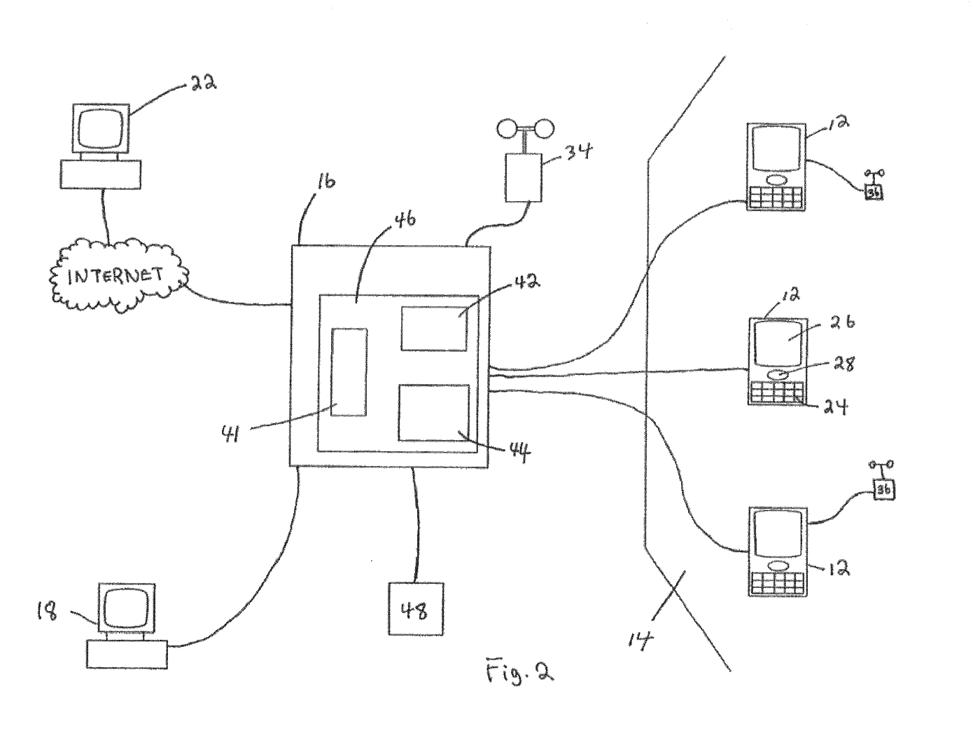

Referring now to FIG. 2, server 16 contains computer memory 46 which in turn contains data base program 42 and communications program 44. Data base program 42 is adapted and configured to store information gathered by server 16 from remote computer consoles 12 and weather station 34. Individual players on a course 14 can enter their scores for each hole of the course into computer consoles 12. This golf score information is read by server 16 and stored in database 42. Server 16 also gathers information from consoles 12 concerning the status of weather station 36 and stores the information concerning the weather conditions from the various weather stations 36 into database 42. Communications program 44 and database 42 are adapted and configured such that communications program 44 can extract information from database 42 and make it available to work station 18, remote computers 22, and remote computer consoles 12. Therefore, a user located at remote computer 22 may access information concerning the weather conditions on particular holes of golf course 14. Golf score information entered into consoles 12 by various individuals is also stored and archived in database program 42. Remote users logging onto computers 22 can access this archival information stored in computer server 16 via communication program 44.

Preferably computer program 44 consists of a web server software program. Furthermore, computer program 44 is also adapted to permit computer server 16 to receive information from remote computers 22. Hence, remote users can reserve tee times, request services or even send messages to the golf course administration simply by logging onto server 16.

Server 16 includes an onboard real time clock 41. Preferably, computer program 42 is adapted to receive time signals from clock 41 and calculate the actual time a player or players are on each hole of the course. In this way, database program 42 can calculate and keep track of playing time for each hole to determine how long groups take, on average, to play particular holes. Program 42 is also adapted to keep track of how long particular players or groups of players are taking to play particular holes in the course. Hence, if a particular group of players are taking too long to play a particular hole, or holes, this information can be recorded by database program 42. Finally, database program 42 can calculate averages for the entire course or for particular holes in the course. Hence, program 42 can calculate and store how long it generally takes to play the entire course or to play particular holes in the course. This information is stored in memory and is made available to terminal 18. This information is helpful in assisting the golf course administrators in maintaining courses, selecting tee times and monitoring the effects of course changes. Also, this information may be made available to remote computers 22 via communications program 44 to permit remote users to determine how long it will take to play the course and how hard the course is to play, both of which may be relevant considerations in a user's decision to book tee times.

The historical data concerning the length of time it takes to play particular holes in the course is also valuable from the point of view of course management. If the course administrators decide to change the layout of particular holes in the course, they can compare the times recorded before and after the changes were made to determine the effect of the changes on the time required to play the holes in question. Hence, course administrators are better able to plan hole layouts to maximize the level of play.

The operation of the system will now be described in greater detail. Would be golf players can obtain information concerning the golf course via computer terminals 22. These players can log onto server 16 and request a tee time. A golf course administrator can monitor the tee time request either directly from computer server 16 or remotely from computer terminal 18. Since database program 42 keeps track of how long it takes to play the course, the administrator can use this information in booking particular tee times. When the players are at their designated tee time, they log into remote console 12 at the first tee. Each player identifies himself or herself and commences playing the hole. Server 16 records the player and the time. As the player progresses from hole to hole, he or she updates his or her score information at each remote console 12. Each time the player updates his or her score information, server 16 updates its stored information concerning that particular player. The course administrator can monitor the progress of particular players or groups of players as they progress through the course. Since server 16 records the location of each player, and since each console 12 is provided with both a video screen and an audio interface, the administrator can communicate with any player as required. Hence, if one group of players are taking too long to play a particular series of holes, the administrator can send a message from computer terminal 18 to the particular consoles 12 which are likely to attract the player's attention. The administrator can tailor the message to encourage the player or players to speed up their game. Since consoles 12 are provided with an audio interface, the messages sent from computer terminal 18 can be auditory. Also, in emergency situations, the administrator can send broadcast messages to all of the consoles 12 to warn players on the course of inclement weather or the like. Under extreme conditions, the administrator can also “lock out” particular remote consoles 12 and display a message on the consoles to warn players to return to the club house.

Players may also communicate with server 16 and the course administrator via consoles 12. Hence, a particular player may obtain requested information from server 16, such as the location and score of another player on the course or the weather conditions at a particular hole. The player may also use console 12 to communicate directly with the course administrator to inform the administrator of a problem on the course or to request a service such as the delivery of refreshments. Players may also communicate with each other using consoles 12; hence, two groups of players may use consoles 12 much like an intercom system to keep in touch with each other during the course of a game.

As each player plays the course, he or she updates his or her score via consoles 12. Each player can display their score and compare that score to that of other players or other groups of players. Each particular player can also monitor the weather and wind conditions at each hole. This information can assist each player in planning their drives. When the players complete the final hole, they enter their score in the last remote console 12. Server 16 updates the information in database 42. If services or refreshments were ordered during the course of the game, information concerning price and payment can be displayed at the final remote console.

After a game is played, a player may retire to the clubhouse to settle his or her account and/or partake in additional refreshments. Computer console 18 is preferably located in the clubhouse to permit players to monitor the scores of other players as their games progress. Also, a player can use console 18 to compare his or her score to the that of other players. The course administrator may use console 18 to determine the overall scores for the day. In some golf courses, it is customary to post the names and scores of the best players for the day. Since this information is automatically recorded by server 16, it is easy for an administrator to post notices concerning these high scoring players. Also, the best scores per hole can also be posted.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

1. A computer scoring and communication system for use by golfers on a golf course having holes and tee boxes, the scoring and communication system comprising;
a computer server having a communications interface and a computer memory,
a plurality of remote computer consoles, each console mounted adjacent a tee box, each said console having a computer display screen and a data inputting device whereby the golfers can enter information into the console, each remote computer console operatively coupled to the communications interface of the server via a communications network,
the computer server being adapted and configured to retrieve the information from each remote computer console and store said information in the memory,
the computer server being further adapted and configured to send messages to the remote computer consoles, said remote computer consoles adapted to display the messages on their computer display screens.

2. A computer scoring and communication system as defined in claim 1 wherein the consoles are adapted to send a plurality of information requests to the server and wherein the server is adapted to display a plurality of requested information on the remote computer consoles in reply to said information requests.

3. A computer scoring and communication system as defined in claim 2 wherein the remote computer consoles are provided with an audio interface for converting electronic messages into audio messages and for converting audio messages into electronic messages.

4. A computer scoring and communication system as defined in claim 2 wherein the server is provided with a communications program for controlling the flow of information to and from the server and the remote computer consoles and a database program for storing and organizing the information in the computer memory, the database program being operatively coupled to the communications program to permit the database program to retrieve information from the remote computer consoles and to transmit information to the remote computer consoles in reply to the information requests.

5. A computer scoring and communications system as defined in claim 4 wherein the server further comprises a real time clock and wherein the database program is adapted to calculate a plurality of time intervals for each player corresponding to the time each player spends on each hole, the database program being further adapted to record said time intervals in the memory.

6. A computer scoring and communications system as defined in claim 5 further comprising a computer terminal operatively coupled to the server, the computer terminal being adapted to display information concerning the time intervals for each player, said computer terminal being further adapted to send messages to selected remote computer consoles via the computer server.

7. A computer scoring and communications system as defined in claim 6 wherein the server is adapted to be operatively coupled to a global communications network and wherein the communications program and the database program are adapted to transmit the information stored in the server memory to the global communications network.

8. A computer scoring and communications system as defined in claim 1 wherein the server is operatively coupled to a plurality of weather stations located through out the golf course, said weather stations adapted to gather information concerning the weather surrounding each station and transmit said weather information to the server, the server adapted to store the weather information in the memory.

9. A computer scoring and communications system as defined in claim 8 wherein the server is adapted to display the weather information on the display screens of the remote computer consoles.
